(19) United States
(12) Patent Application Publication
(10) Pub. No.: US 2002/0046500 A1
(43) Pub. Date: Apr. 25, 2002

(54) Security door

(75) Inventor: John Hingston, Kenthurst (AU)

Correspondence Address: LADAS & PARRY, Suite 2100, 5670 Wilshire Boulevard, Los Angeles, CA, 90036-5679, US

(73) Assignee: Strategic Manufacturing Pty. Ltd.

(21) Appl. No.: 09/948,448

(22) Filed: Sep. 7, 2001

Related U.S. Application Data
(63) Continuation of application No. 09/366,923, filed on Aug. 4, 1999, now abandoned.

(30) Foreign Application Priority Data
Aug. 5, 1998 (AU) PP 5068

(51) Int. Cl. E06B 3/00

(52) U.S. Cl. 49/501

(57) ABSTRACT

A security door (1) including:

a reinforcing high strength sub-structure (2) defining a peripheral frame (3) sized to closably fit within a corresponding doorway (4) and a reinforcing barrier (5) of high strength material extending across the peripheral frame, a first edge (6) of the frame being adapted to be hingedly mounted to the doorway (4), and a second edge (7) of the frame, being adapted for interaction with at least one door locking means (8); and

internal (11) and external (12) modular cladding elements adapted to be mounted to respective faces of the sub-structure (2).

### TECHNICAL FIELD

The present invention relates to doors and door assemblies and in particular to security doors and security door assemblies which include secure door surrounds.

### BACKGROUND ART

The invention has been developed primarily for use as a home security door or as a home security door assembly including secure door surrounds and will be described hereinafter with reference to these applications. However, it will be appreciated that the invention is not limited to these fields of use.

In order to guard against the increasing frequency of home invasions and burglaries home owners have, up until now, fitted separate additional security screen doors to external doorways. These are typically used in conjunction with conventional doors. Such security screen doors normally include a metal lattice work of some form. In most instances such additional external security doors and grilles are visually unacceptable and are often reminiscent of prisons and other high security facilities. Further, they often detract from the aesthetics of the carefully selected and often expensive main entrance door in front of which the security grille is disposed. Generally, the more effective and substantial the security door or grille, the less aesthetically acceptable the design becomes as an integral external feature of the home. Further, if a home is later renovated in a different style, it may be necessary to change the entire security door in order to match the change in style.

In addition to visual considerations there are also structural and safety disadvantages associated with such security screen doors. In this regard the security of an entrance is only as strong as its weakest link and such doors are typically fitted as an after thought, often in response to an increase in crime rate in an area or an actual break-in. As a result the security door is usually fitted to an existing doorframe, which is typically wooden, and thus the potential security benefit of the door is compromised.

Also, in the event of a fire, or some other emergency situation where it is necessary to evacuate the home, two doors must be unlocked before the occupants can escape.

It is an object of the present invention to overcome or ameliorate at least one of the disadvantages of the prior art, or to provide a useful alternative.

### SUMMARY OF THE INVENTION

According to a first aspect of the invention there is provided a security door including:

a reinforcing high strength sub-structure defining a peripheral frame sized to closably fit within a corresponding doorway and a reinforcing barrier of high strength material extending across the peripheral frame, a first edge of the frame being adapted to be hingedly mounted to the doorway, and a second edge of the frame, being adapted for interaction with at least one door locking means; and

internal and external modular cladding elements adapted to be mounted to respective faces of the sub-structure.

Preferably the high strength material is steel or aluminium, and the cladding elements in the preferred form include timber, glass, coated or laminated substrates and any other suitable materials.

In a preferred form the locking means is secured to the sub-structure and the door further optionally includes security cover plates also secured to the sub-structure underneath the cladding elements.

In preferred embodiments the barrier is an open steel or aluminium mesh structure.

Preferably the internal and external cladding members are mounted to the substructure so as to define a cavity about the reinforcing barrier. Desirably the cavity is filled with a suitable filler material, such as high density foam or the like, to further integrate the barrier into the completed door structure and also provide additional acoustic and insulation properties as well as a general “solid” door feel.

Preferably the reinforcing barrier has an open structure including a number of discrete cavities into which various elements of door furniture, including door locking means, door bells, security windows and others, can be secured and thus integrated into the door.

According to a second aspect of the invention there is provided a door assembly, said assembly including:

a security door according to the first aspect, in combination with a corresponding doorway or door surround of high strength material, hinge means connecting said door to the doorway or door surround and at least one door locking means for securing the door in a locked position to the door surround or doorway.

Preferably the doorway or door surround includes means to integrate the frame into a surrounding building structure.

Preferably the doorway includes a door frame having a first frame element adapted for the hinged attachment of the security door and a second frame element adapted to cooperate with the door locking means to releasably close the security door. More preferably the first frame element is also adapted for the hinged attachment of an optional screen door. Desirably the second frame element is of generally “T” shaped cross section, thus providing stop means for the closure of the security door and the screen door, if present. More preferably the second frame element is also adapted to cooperate with a screen door locking means to releasably close the screen door.

In another preferred form the door surround includes a door surround frame adapted to captively retain a door surround panel which may be reinforced or unreinforced. Alternatively, in other preferred forms the door surround includes a reinforcing barrier of high strength material extending across the door surround frame, and modular cladding elements adapted to be mounted to each side of the door surround frame.

### BRIEF DESCRIPTIONS OF THE DRAWINGS

Preferred embodiments of the invention will now be described, by way of example only, with reference to the accompanying drawings in which:

FIG. 1 is a front elevation of a first embodiment security door according to the invention;

FIG. 2 is a front elevation of a second embodiment security door assembly according to the invention;

FIG. 3a is a perspective view of a section of a frame component of a first embodiment door way or door surround according to the invention;

FIG. 3b is an enlarged sectional view of a first embodiment doorway or door surround according to the invention;

FIG. 3c is another enlarged sectional view of a first embodiment doorway or door surround according to the invention;

FIG. 4 is a cross sectional plan view of a first embodiment security door assembly according to the invention;

FIG. 4a is a cross-sectional plan view of a second embodiment security door assembly according to the invention;

FIG. 5 is a front elevation of a first embodiment door surround according to the invention; and

FIG. 6 is a cross sectional view of the door surround of FIG. 5.

### MODES FOR CARRYING OUT THE INVENTION

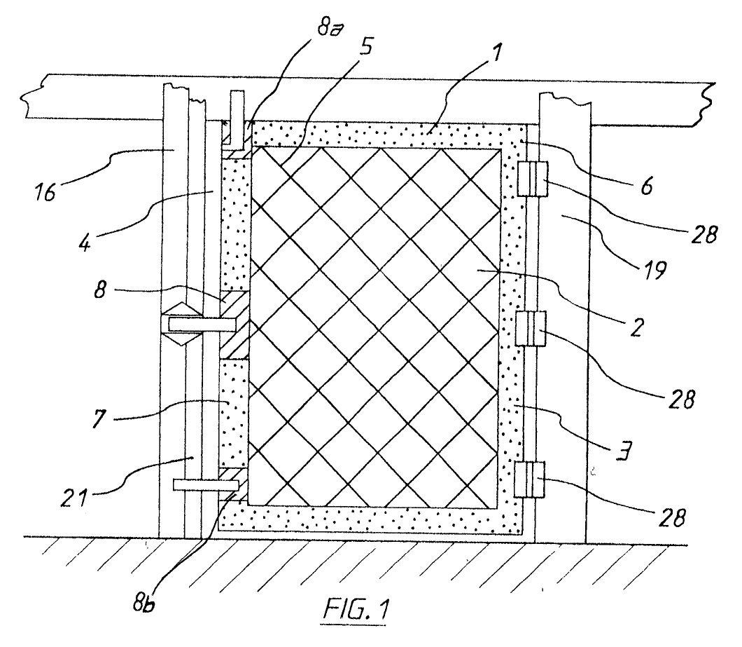

Referring in particular to FIG. 1 the security door 1 includes a reinforcing high strength sub-structure 2 which defines a peripheral frame 3 sized to closably fit within a corresponding doorway 4 of a home or other building. A reinforcing barrier 5 of high strength material extends across the peripheral frame 3. The frame includes a first edge 6 adapted to be hingedly mounted to the doorway, and a second edge 7 adapted for interaction with at least one door locking means 8. The door also includes internal and external modular cladding elements 11 and 12 (not shown) which are adapted to be mounted to respective faces of the sub-structure.

In a preferred form the high strength material is steel or aluminium, however other materials such as high tensile strength poly-carbonates or ceramics can be used where there is a greater threat from firearms as in gaols or banks.

As shown to advantage in FIG. 1 the reinforcing barrier 5 is, in this embodiment, in the form of an open mesh structure. One benefit of such an open structure is that the discrete cavities defined by the mesh may be used to secure and thereby integrate various elements of door furniture into the door 1. Examples of such furniture are locking means, door bells, security windows or the like. Alternatively, the barrier can comprise a single sheet of steel or some other material.

The security door 1, or alternatively the surrounding doorway is fitted with a door locking means 8. This is, in this instance, provided in the form of a single, conventional key operated deadbolt, together with two secondary deadbolts 8a and 8b, but in other embodiments suitable mechanical, electrical or electronic mechanisms may be used to effect the locking function. In the case where the locking mechanism is electronic then element 8 may become the door knob for pulling (rather than rotating for) opening or closing the door. Other embodiments of the security door may be provided with multiple locking points all actuated by a central mechanically or electronically activated mechanism. Some available options for such electronic mechanisms are: electronic key entry; remote locking/unlocking of the door by way of a remote beeper key as used for cars; a keypad attached to the door and programmed with a PIN number to allow entry; or a keypad as above with the added feature of a random location of each number to prevent an observer from noting the PIN number entered and also allowing the even wear of each keypad position.

Such electronic mechanisms may also include a panic exit function such as a luminous button or the like inside the home to provide quick exit from the home in case of emergency. Once the door is closed and the locking mechanism activated, it may be deactivated by pressing the luminous button. The inclusion of a rechargeable battery in such locking mechanisms ensures operation in the event that power is interrupted.

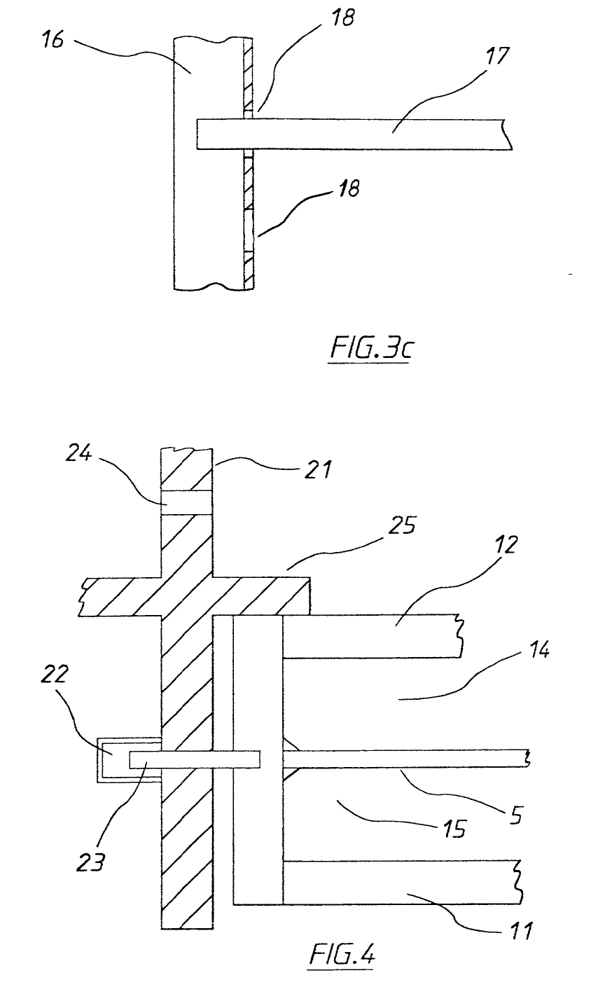

To prevent unauthorised access to the locking mechanism by removing or damaging the modular cladding elements 11 and 12, high strength cover plates may be secured to reinforced barrier 5 to shield the locking mechanism (see FIGS. 4 and 4a). Similarly, if locking means 8 is secured to a doorframe or door surround and second edge 7 is adapted for interaction with locking means 8, then cover plates may be used to shield it from unauthorised tampering.

Shown to advantage in FIG. 4, internal and external modular cladding elements 11 and 12 respectively are adapted to be mounted by any suitable means to each side of the sub-structure 2, to provide the security door with a attractive appearance. Cladding elements 11 and 12 may be made from combinations of timber, security glass, coated or laminated substrates or any other suitable material. Alternatively, elements 11 and 12 may be of unitary construction. Such flexibility of design allows the door to be constructed to complement both the internal and external decors of the home as each element can be manufactured from a different material and finished to match different styles.

Another advantage of such a system is the reduced quantity of timber used in the production of a door. This is especially significant in relation to many ornamental hardwood timbers which are typically rare and expensive. The modular system also reduces the stock levels a manufacturer is required to maintain, as doors can be made to order.

The cladding elements may, in one form, be adapted for permanent mounting to the high strength sub-structure. To this end, screws, bolts, rivets, welding, adhesives or other conventional fastening techniques may be used. In this manner, access to the doors inner cavity can be made difficult to achieve. However, in the even that the decor of the building is updated, it would be difficult to remove the cladding elements without damaging them.

In an alternate form, the cladding elements may be releasably mounted to the door. For example, the cladding elements may have keying formations adapted to interact with corresponding slots or apertures in the high strength sub-structure. Such a door could include a locking mechanism to secure the mounted elements until their replacement is required. For the sake of security, such locking mechanisms should only be accessible when the door is open.

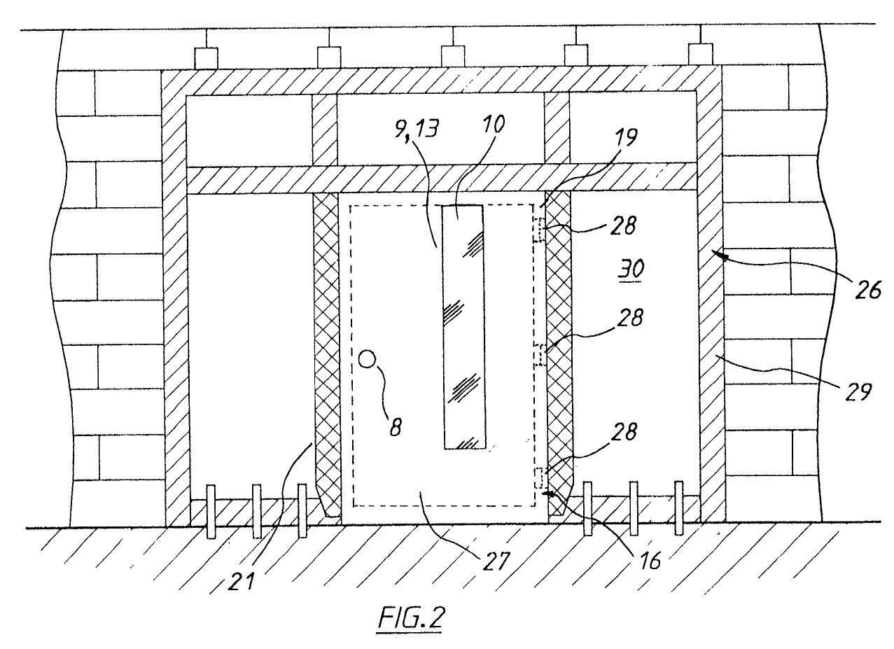

In the event that the home is renovated or redecorated the original modular cladding elements 11 and 12 can be removed and replaced with new cladding elements that will complement the new decor. During construction of a new home the builder may apply a set of cladding elements to the installed door that will remain in place for the duration of construction. After the home is otherwise complete the builders cladding elements can be replaced by the owners more ornamental ones. By this method inadvertent damage is prevented during construction. In embodiments of the invention that include glass panels 10 or the like integral to the door, corresponding apertures 13 are formed in the cladding elements 11 and 12 (as shown in FIG. 2).

In some embodiments of the invention, one of which is shown in FIG. 2, apertures may be made in the reinforcing barrier 5 for the integration into the door of windows, delivery slots or the like. It will be appreciated that, whilst the size and configuration of these panels may effect the overall security of the door 1, the shape and configuration can vary widely in accordance with the owner's preferences. In such embodiments the aperture will include a frame 9 into which an appropriately sized panel 10 of security glass, glass, timber or the like is located before modular cladding elements 11 and 12 are fitted.

As shown in FIG. 4, cladding elements 11 and 12 when fitted define cavities 14 and 15. These cavities can be filled with a high density foam or the like to more uniformly integrate the reinforcing barrier 5 into door 1. Additionally, such filling can provide noise and heat insulation properties to the door as well as preventing a hollow sound when knocked on. Incorporation of the filling also provides a general “solid” door feel.

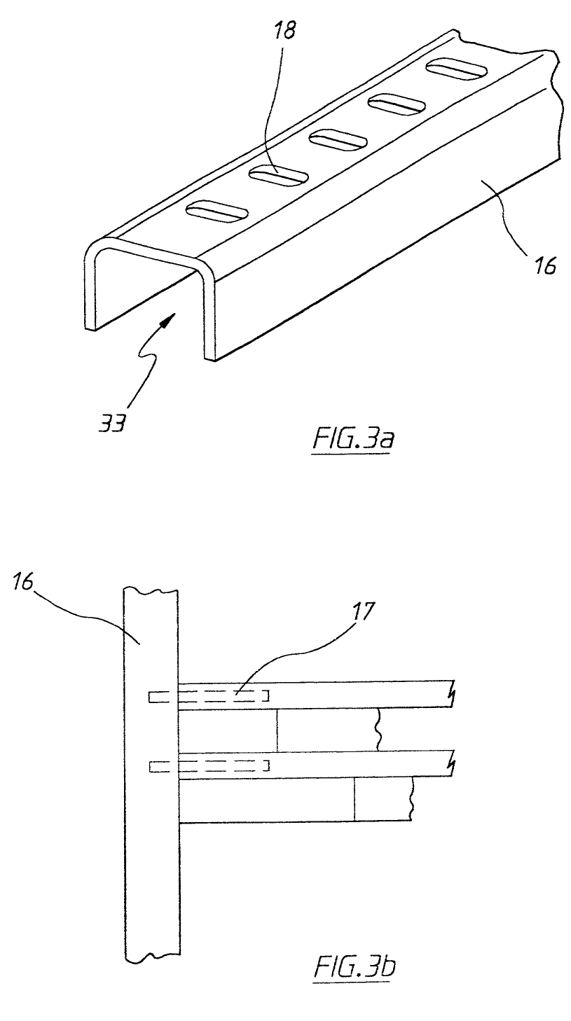

In order to securely integrate the security door 1 into a home or other building, a secure door frame 16 is fitted within the doorway 4 as shown in FIG. 1. Ideally, frame 16 is attached to the building by use of keying bars 17 which fit into slots 18 in the frame and then project into the surrounding structure as shown in FIG. 3b. If the door frame is being fitted to a new home or other building then keying bars 17 can be suitably spaced to fit between bricks and subsequently be mortared into the structure. Alternatively, if the new home is of timber or other non brick material construction then the frame 16 may be bolted or otherwise secured to sufficiently strong parts of the building frame. If the frame 16 is fitted to an existing brick or concrete home or building then conventional masonry bolts or the like, extending through slots 18, may be used to fix the frame to the surrounding structure.

The door frame 16 includes a first frame element 19 which is adapted for the hinged attachment of security door 1 as well as an optional screen door 20 (not shown). Frame 16 also includes a second frame element 21 adapted to cooperate with door locking means 8 to releasably close security door 1 as shown in FIG. 1. FIGS. 4 and 4a show that frame element 21 can be provided with an aperture 22 to accept the tongue 23 of door locking means 8 to allow the releasable closure of door 1. A similar aperture 24 is provided to allow the releasable closure of outwardly opening screen door 20. As shown in FIG. 4, frame element 21 can be of generally “T”-shaped cross section, the stem 25 of the “T” providing stop means for the closure of door 1 as well as screen door 20, if present. In an alternative embodiment illustrated in FIG. 4a, the frame element is adapted so that security door 1 opens outwardly. In this form, no external screen door is required.

The configuration shown in FIG. 4 is preferred for use in homes and the like as it provides for an inward swinging main door and also for the use of an external fly screen or security mesh door 20 (not shown). Advantageously, the screen or mesh door 20 can allow a breeze to blow through the dwelling when door 1 is left open.

The alternative embodiment shown in FIG. 4a provides for an outwardly opening door. Such a door may be unsuitable for use in some applications such as apartments due to laws regarding doors opening into passageways. However, where permitted this configuration may be capable of offering enhanced security. These benefits arise from stem 25 being on the interior side of the door thus making it even more difficult to “kick in” the door. To protect the exposed tongue 23 from “jemmying”, the external cladding member 12 may be extended past the edge of the door thereby closing access to the tongue.

Referring to FIG. 2, a doorway assembly includes a security door 1 in combination with a door surround 26 of high strength material. Security door 1 is connected to door surround 26 of hinges 28. Alternatively, continuous piano type hinges may be used. One door locking mechanism 8 is provided to secure security door 1 in a locked position to the door surround. Door surround 26 is secured to the home in a similar fashion to the door frame described earlier. Door surround 26 includes a door surround frame 29 adapted to captively retain a door surround panel 30 which may be reinforced or unreinforced. In preferred embodiments panel 30 is constructed of bullet proof glass, security glass or the like. In other embodiments where conventional glass, leadlight or other low strength materials such as timber are used in panels 30, such panels should be sized and located such that, if broken, they do not facilitate access to the internal lock actuator or quick exit button.

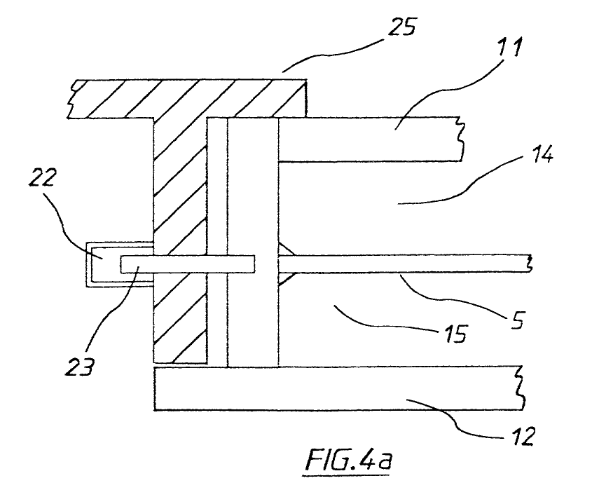

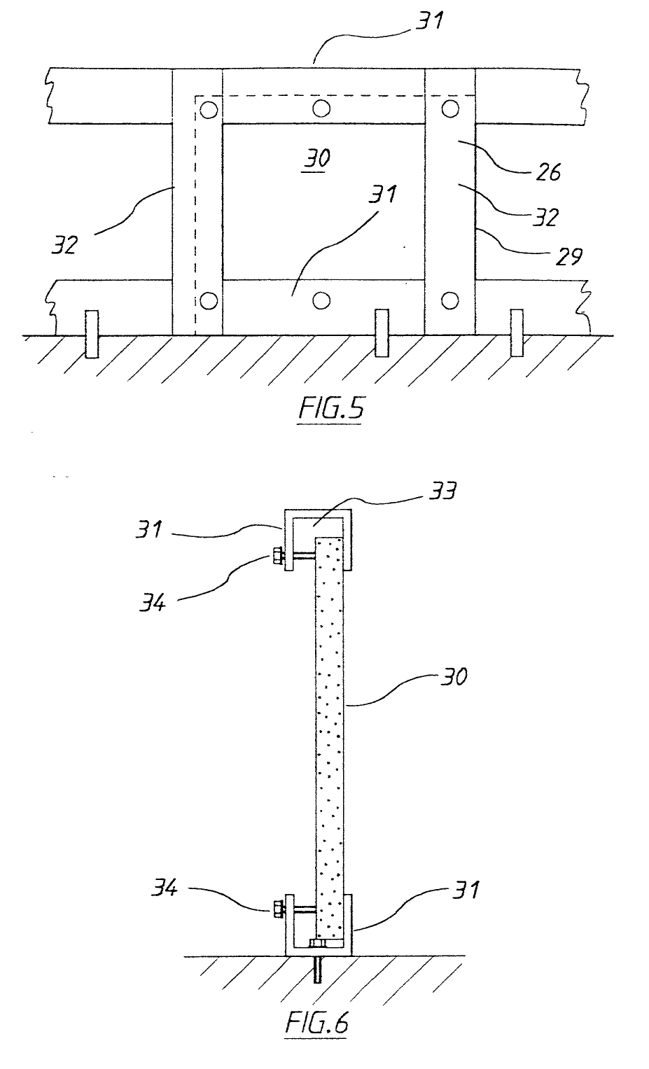

As shown in FIGS. 5 and 6, door surround frame 29 is constructed of end elements 31 and side elements 32. Elements 31 and 32 are provided with channels 33 into which panel 30 is fitted. First frame element 19 and second frame element 21 are secured to those segments of the door surround frame 29 that define the doorway 4. Alternatively, elements 19 and 21, in combination with door surround frame elements 31 and 32 define the door surround frame 29.

In a preferred embodiment the panel 30 is sized such that after a first edge is introduced fully into channel 33 of a first side or top element 31, a second, opposite edge may then be slid into channel 33 of a second, opposite side 32 or bottom element 31. This is done in a similar manner to the fitting of a sliding glass door into the top and bottom tracks along which the door slides. Once in position panel 30 is retained by the channels and secured by high strength bolts 34 that are recessed into end elements 31.

In other embodiments the door surround includes a reinforcing barrier of high strength material extending across the door surround frame, and modular cladding elements adapted to be mounted to each side of the door surround frame, in a similar fashion to that used for the security door 1.

Although the invention has been described with reference to specific examples it will be appreciated by those skilled in the art that the invention may be embodied in many other forms.

The claims defining the invention are as follows:

1. A security door including:
a reinforcing high strength sub-structure defining a peripheral frame sized to closably fit within a corresponding doorway and a reinforcing barrier of high strength material extending across the peripheral frame, a first edge of the frame being adapted to be hingedly mounted to the doorway, and a second edge of the frame, being adapted for interaction with at least one door locking means; and
internal and external modular cladding elements adapted to be mounted to respective faces of the sub-structure.

2. A security door according to claim 1 wherein the barrier defines an open mesh structure.

3. A security door according to claim 1 wherein one or more of said modular cladding elements are selectively demountable from the sub-structure.

4. A security door according to claim 1 wherein the locking means is secured to the sub-structure and the door also includes a security cover plate secured to the substructure.

5. A security door according to claim 1 wherein the internal and external cladding elements are mounted to the sub-structure so as to define a cavity about the reinforcing barrier.

6. A security door according to claim 5 wherein at least part of the cavity is filled with a suitable filler material.

7. A security door according to claim 6 wherein the filler material includes high density foam or the like.

8. A security door according to claim 1 wherein the reinforcing barrier has an open structure including a number of discrete cavities into which various elements of door furniture, including door locking means, door bells, security windows and others, can be secured and thus integrated into the door.

9. A security door according to claim 1 wherein the high strength material is steel or aluminium.

10. A security door according to claim 1 wherein the cladding elements include timber, glass, coated or laminated substrates or any other suitable materials.

11. A door assembly, said assembly including:
a security door according to any one of the preceding claims, in combination with a corresponding doorway or door surround of high strength material, hinge means connecting said door to the doorway or door surround and at least one door locking means for securing the door in a locked position to the door surround or doorway.

12. A door assembly according to claim 11 wherein the doorway or door surround includes means to integrate the frame into a surrounding building structure.

13. A door assembly according to claim 11 wherein the doorway includes a door frame having a first frame element adapted for the hinged attachment of the security door and a second frame element adapted to cooperate with the door locking means to releasably close the security door.

14. A door assembly according to claim 13 wherein the first frame element is also adapted for the hinged attachment of a screen door.

15. A door assembly according to claim 13 wherein the second frame element is of generally “T” shaped cross section, thus providing stop means for the closure of the security door and the screen door.

16. A door assembly according to claim 13 wherein the second frame element is adapted to cooperate with a screen door locking means to releasably close the screen door.

17. A door assembly according to claim 11 wherein the door surround includes a door surround frame adapted to captively retain a door surround panel.

18. A door according to claim 17 wherein said door surround panel includes high strength reinforcing means.

19. A door assembly according to claim 17 wherein the door surround includes a reinforcing barrier of high strength material extending across the door surround frame, and modular cladding elements adapted to be mounted to each side of the door surround frame.
